(19) United States
(12) Patent Application Publication
(10) Pub. No.: US 2026/0141698 A1
(43) Pub. Date: May 21, 2026

(54) METHOD FOR GENERATING A TRAINING DATA SET, TRAINING DATA SET, METHOD FOR TRAINING A MAP GENERATION MODULE, AND MAP GENERATION MODULE

(71) Applicant: Robert Bosch GmbH, Stuttgart (DE)

(72) Inventors: Christian Loewens, Hannover (DE); Thorben Funke, Sarstedt (DE)

(21) Appl. No.: 19/370,834

(22) Filed: Oct. 28, 2025

(30) Foreign Application Priority Data
Nov. 15, 2024 (DE) 10 2024 210 994.0

(51) Int. Cl. G06V 10/774; G06V 20/56

(52) U.S. Cl. CPC G06V 10/7747; G06V 20/56

(57) ABSTRACT

A computer-implemented method for generating a training data set for training a map generation module. The method includes: ascertaining a position value of the surroundings sensor data, wherein the position value of the surroundings sensor data is defined by a pose of the mobile unit; ascertaining a deviating position value of the surroundings sensor data, wherein the deviating position value deviates from the position value of the surroundings sensor data by a deviation value; ascertaining a map section of the electronic map based on the deviating position value, wherein the map section is disposed around the deviating position value of the surroundings sensor data; grouping the surroundings sensor data and the ascertained map section into a data set unit; and integrating the data set unit into the training data set. A method for training a map generation module is also described.

### CROSS REFERENCE

The present application claims the benefit under 35 U.S.C. § 119 of Germany Patent Application No. DE 102024 210 994.0 filed on November 15, 2024, which is expressly incorporated herein by reference in its entirety.

### FIELD

The present invention relates to a method for generating a training data set for training a map generation module for generating a map representation. The present invention also relates to a corresponding method for training a map generation module, a map generation module, and a training data set.

### BACKGROUND INFORMATION

For autonomous driving of vehicles, precise maps are essential. Certain methods for generating such maps and using AI-based map generation modules are described in the related art. Certain methods for training such map generation modules are described I the related art as well.

### SUMMARY

An object of the present invention includes to provide an improved method for generating a training data set for training a map generation module, an improved method for training a map generation module, an improved training data set and an improved map generation module.

This object may be achieved by the methods, the training data set and the map generation module of the present invention. Advantageous embodiments of the present invention are disclosed herein.

According to one aspect of the present invention, a computer-implemented method for generating a training data set for training a map generation module is provided. According to an example embodiment of the present invention, the method comprises: receiving surroundings sensor data from a surroundings sensor of a mobile unit, wherein the surroundings sensor data depict the surroundings of the mobile unit at least partially; receiving map data from an electronic map, wherein the electronic map depicts the surroundings of the mobile unit at least partially and/or comprises information relating to the surroundings; ascertaining a position value of the surroundings sensor data, wherein the position value of the surroundings sensor data is defined by a pose of the mobile unit; ascertaining a deviating position value based on the position value, wherein the deviating position value deviates from the position value of the surroundings sensor data by a deviation value; ascertaining a map section of the electronic map based on the deviating position value, wherein the map section is disposed around the deviating position value of the surroundings sensor data; grouping the surroundings sensor data and the ascertained map section into a data set unit; and integrating the data set unit into the training data set.

This makes it possible to achieve a technical advantage that an improved method for generating a training data set for training a map generation module can be provided. To generate the training data set, surroundings sensor data from at least one surroundings sensor of a mobile unit are taken into account, wherein the surroundings sensor data depict the surroundings of the respective mobile unit at least partially. Map data from an electronic map are also taken into account to generate the training data set. The electronic map goes beyond the surroundings of the mobile unit and includes a variety of information relating to the surroundings. First, a position value of the surroundings sensor data is ascertained. The position value is defined by a pose of the mobile unit at the time the surroundings sensor data were recorded. This is used to ascertain a deviating position value which deviates from the position value of the surroundings sensor data by a selectable but defined deviation value.

The deviating position value is used to generate a map section from the electronic map. The map section is defined here as a spatial region disposed around the deviating position value and depicts the surroundings of the mobile unit at least partially. The ascertained map section thus corresponds to the representation of the electronic map of the surroundings of the mobile unit depicted by the surroundings sensor data.

The ascertained map section and respective associated surroundings sensor data are then combined into a data set unit and integrated as a unit into the training data set.

The surroundings sensor data and the respective map section of the data set unit generated in accordance with the above steps thus have different position values. The position value of the surroundings sensor data corresponds to the actual position value, i.e., the actual pose, at the time the surroundings sensor data were recorded. The position value of the map section corresponds to the deviating position value, which deviates from the actual position value of the surroundings sensor data by the stated deviation value. This can be used to simulate inaccuracies in the pose determination when the surroundings sensor data are recorded.

The intended deviation between the two position values of the surroundings sensor data and the associated map section allows the map generation module to be trained to corresponding inaccuracies in the pose determination during the recording of the surroundings sensor data by the mobile units during subsequent training of the map generation module based on the correspondingly generated training data set.

This enables more precise training of the map generation module, as a result of which the correspondingly trained map generation module can produce more precise maps later when it is being used, even with inaccurate pose determinations.

According to an example embodiment of the present invention, the correspondingly trained map generation module can thus also be used on less high-quality mobile units which, due to the lower quality of the surroundings sensors, carry out less precise pose determination when the surroundings sensors are recording. Modifying the position value of the surroundings sensors by the freely selectable but nonetheless defined deviation value and generating the deviating position value accordingly makes it possible to easily take such inaccuracies in the pose determination into account during the training of the map generation module.

According to one example embodiment of the present invention, the deviating position value is ascertained by shifting the position value of the surroundings sensor data along a shift axis by a shift value, and/or the deviating position value is ascertained by rotating the position value of the surroundings sensor data about a rotation axis by a rotation value.

This makes it possible to achieve the technical advantage of enabling a simple deviation between the position value of the surroundings sensor data and the deviating position value. The deviation between the position value and the deviating position value can include a shift along the translation axes, which simulates a deviating position of the mobile unit relative to an absolute reference system. Alternatively or additionally, the deviation between the position value and the deviating position value can include a rotation about a rotation axis, which represents a deviating orientation of the mobile unit relative to the absolute reference system.

According to one example embodiment of the present invention, the deviating position value is ascertained based on a random distribution of the position value, wherein the random distribution is limited by a predefined limit value, and wherein the predefined limit value defines a maximum permissible deviation of the deviating position value from the position value.

This makes it possible to achieve the technical advantage that taking into account the random distribution makes it easy to ascertain the deviating position value. The random distribution can be taken into account as a normal distribution or uniform distribution disposed around the actual position value of the surroundings sensor data, for example. This makes it possible to simulate the inaccuracy in the mobile unit pose determination when ascertaining the surroundings sensor data. The deviation between the position value and the deviating position value can be limited by a predefined limit value, which prevents the occurrence of excessively deviating position values and prevents the creation of such useless data for the training of the map generation module. The predefined limit value is freely selectable and can be ascertained depending on the desired precision of the training.

According to one example embodiment of the present, the position value of the surroundings sensor data is based on data from a global navigation satellite system, wherein the deviating position value is ascertained based on the position value taking into account an error value of the position value ascertained based on the data from the global navigation satellite system.

This makes it possible to achieve the technical advantage of enabling a simple ascertainment of the deviation value between the position value of the surroundings sensor data and the deviating position value. The inaccuracies or errors of the global navigation satellite system, the data of which are used to generate the position values of the surroundings sensor data, are used as the deviation value. The deviating position value can, for instance, be obtained by adding the actual position value to the specified error values of the global navigation satellite system.

In particular when taking into account surroundings sensor data from a plurality of different mobile units, the deviations between the position values of the surroundings sensor data provided by the different mobile units can be used as the deviation value. The ascertained deviations between the position values relate to surroundings sensor data provided by different mobile units for a comparable pose.

According to one example embodiment of the present invention, the map section is converted into a bird's eye view.

This makes it possible to achieve the technical advantage that the bird's eye view enables the map generation module to more precisely take the information in the map section into account for the map representation.

According to one example embodiment of the present invention, a plurality of data set units with different deviation values between the respective position value and the deviating position value of the respective surroundings sensor data are generated.

This makes it possible to achieve the technical advantage that it enables the generation of an improved training data set, in which different data set units with different deviation values between the position values of the respective surroundings sensor data and the deviating position values of the associated map sections can be provided. The different deviation values between the position values of the surroundings sensor data and the deviating position values of the associated map sections allow different values of the inaccuracy of the pose determination when generating the surroundings sensor data to be taken into account in the training of the map generation module. This in turn enables improved training of the map generation module and therefore improved performance of the correspondingly trained map generation module.

According to one example embodiment of the present invention, the surroundings sensor data are based on fleet data from a plurality of mobile units.

This makes it possible to achieve the technical advantage that taking into account the fleet data of the plurality of mobile units in relation to the provided surroundings sensor data makes available a large amount of surroundings sensor data. It also makes it possible to achieve a high level of diversity in the provided surroundings sensor data, so that systematic errors when recording the sensor data, which may be present in individual mobile units, for example, can largely be reduced. The surroundings sensor data of the fleet of mobile units can furthermore be used to include a wide variety of spatial regions or surroundings depicted by the respective surroundings sensor data in the training data set and consequently in the training of the map generation module.

According to one example embodiment of the present invention, the mobile unit is a vehicle, and the electronic map is embodied as an electronic road map of a road network.

This makes it possible to achieve the technical advantage of providing an improved training data set for use in vehicle navigation taking into account the information from electronic road maps. The correspondingly trained map generation module is thus suitable for use in vehicles for navigating the vehicles in road traffic.

According to one example embodiment of the present invention, the surroundings sensor data comprise data from the following list: radar data, LiDAR data, ultrasonic data, camera data, and/or the information of the electronic map comprises information relating to elements from the list: lane marking, lane center line, road signs, topological features.

This makes it possible to achieve the technical advantage that precise surroundings sensor data and meaningful information from the electronic road map can be taken into account in the training data set.

According to one aspect of the present invention, a training data set for training a map generation module is provided, wherein the training data set comprises a plurality of data set units each comprising surroundings sensor data and a corresponding map section, and wherein the training data set was generated according to the method for generating a training data set according to one of the above-described example embodiments of the present invention.

This makes it possible to achieve a technical advantage that an improved training data set can be provided. The training data set comprises data set units generated which are according to the above-described method steps and have different deviation values between the position values of the surroundings sensor data and the deviating position values of the associated map sections. The improved training data set can thus be used in training a map generation module and makes it possible to train the map generation module based on deliberately considered inaccuracies in the pose determination when generating the surroundings sensor data.

According to one aspect of the present invention, a method for training a map generation module is provided, which comprises: providing a training data set according to the invention; training the map generation module to generate a map representation based on the data set units of the training data set it, wherein the map representation comprises information from the map representation and information from the surroundings sensor data and depicts the surroundings of the mobile unit at least partially.

This makes it possible to achieve the technical advantage of enabling improved training of the map generation module. The improved training data set allows inaccuracies in the pose determination when the surroundings sensor data are recorded by the mobile units to be taken into account in the training. The respective map generation module can thus also be used for mobile units with a correspondingly inaccurate pose determination.

According to one example embodiment of the present invention, the training of the map generation module comprises a first training phase and a temporally later second training phase, wherein, in the first training phase, the map generation module is trained on data set units of the training data set which each have a deviation value between the position value and the deviating position value that is less than or equal to a predefined limit value, and wherein, in the second training phase, the map generation module is trained on data set units of the training data set which each have a deviation value between the position value and the deviating position value that is greater than the predefined limit value.

This makes it possible to achieve the technical advantage of enabling improved training of the map generation module. For this purpose, in a first training phase, the map generation module is first trained on data set units in which deviation values between the position value of the surroundings sensor data and the deviating position value of the respective map section are less than or equal to a predefined limit value. For example, the map generation module can first be trained on data set units in which only the actual position values of the surroundings sensor data are taken into account without a respective deviation value.

According to an example embodiment of the present invention, after completion of the first training phase, in which the map generation module was trained based on the surroundings sensor data and map sections with actual position values, the second training phase takes into account data set units containing deviation values between the position values of the surroundings sensor data and the deviating position values of the associated map sections.

First training the map generation module on the unadulterated data with original position values, and taking into account the data set units with substantial deviation values between the position values of the surroundings sensor data and the deviating position values of the map sections only after the corresponding (pre)training, makes it possible to achieve a more precise training of the map generation module. The correspondingly trained map generation module is thus capable of carrying out map generation on both surroundings sensor data with precise pose determination and surroundings sensor data with inaccurate pose determination.

According to one example embodiment of the present invention, in the second training phase, a proportion of the data set units with a deviation value greater than the predefined limit value used for training is gradually increased, and/or, in the second training phase, data set units with gradually increasing deviation values between the position value and the deviating position value are used for training.

This makes it possible to achieve the technical advantage that the training of the map generation module can be further improved. For this purpose, in the second training phase, as the training period continues, the proportion of data set units with a substantial deviation value between the position value of the surroundings sensor data and the deviating position value of the map sections being used is increased. Gradually increasing the proportion of data set units with a corresponding deviation value makes it possible to gradually introduce the trained map generation module to the surroundings sensor data with the inaccurate pose determination. Alternatively or additionally, in the second training phase, as the training period increases, the deviation values between the position values of the surroundings sensor data and the deviating position values of the associated map sections can be increased. For this purpose, data set units with increasingly large deviation values are used for training as the training period increases. This allows the correspondingly trained map generation module to again be gradually introduced to surroundings sensor data with ever increasing inaccuracies in the pose determination.

According to one aspect of the present invention, a map generation module is provided, wherein the map generation module has been trained according to the method for training a map generation module according to one of the above-described embodiments of the present invention, and wherein the map generation module is configured to generate a map representation of the surroundings of the mobile unit based on surroundings sensor data and an electronic map.

This makes it possible to achieve a technical advantage that an improved map generation module can be provided. The improved map generation module is configured to provide map generation based on surroundings sensor data and map sections of an electronic road map, and is capable of carrying out this map generation based on surroundings sensor data with inaccurate pose determination of the respective mobile units.

According to one aspect of the present invention, a computing unit is provided, which is configured to execute the method for generating a training data set for training a map generation module according to one of the above-described embodiments of the present invention and/or the method for training a map generation module according to one of the above-described embodiments of the present invention.

According to one aspect, a computer program product is provided, which comprises instructions that, when the program is executed by a data processing unit, cause said data processing unit to carry out the method for generating a training data set for training a map generation module according to one of the above-described embodiments of the present invention and/or the method for training a map generation module according to one of the above-described embodiments of the present invention.

Example embodiments of the present invention are described with reference to the figures.

### BRIEF DESCRIPTION OF THE DRAWINGS

FIG. 1 shows a schematic illustration of a method for generating a training data set for training a map generation module according to one example embodiment of the present invention.

FIG. 2 shows a schematic illustration of a method for training a map generation module according to one example embodiment of the present invention.

FIG. 3 shows a flow chart of a method for generating a training data set for training a map generation module according to one example embodiment of the present invention.

FIG. 4 shows a flow chart of a method for training a map generation module according to one example embodiment of the present invention.

FIG. 5 shows a schematic illustration of a computer program product, according to an example embodiment of the present invention.

### DETAILED DESCRIPTION OF EXAMPLE EMBODIMENTS

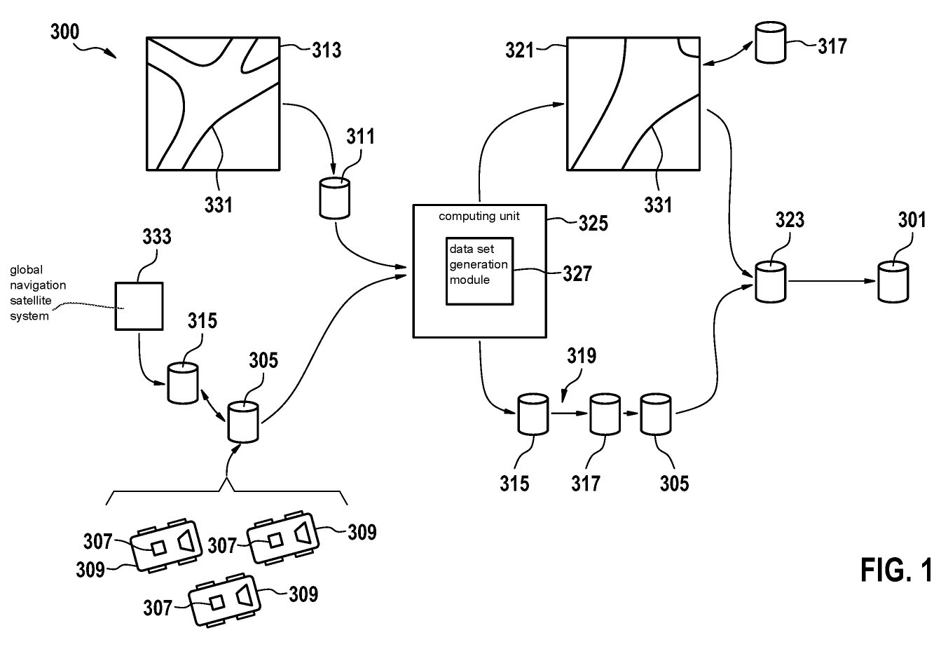

FIG. 1 shows a schematic illustration of a method 100 for generating a training data set 301 for training a map generation module 303 according to one embodiment.

In the shown embodiment, the system 300 comprises a computing unit 325 on which a data set generation module 327 is being executed. The data set generation module 327 is configured to carry out the method 100 according to the invention for generating a training data set 301 for training a map generation module 303.

To generate the training data set 301, the data set generation module 327 first receives surroundings sensor data 305 from at least one surroundings sensor 307 of at least one mobile unit 309. The surroundings sensor data 305 depict the surroundings of the respective mobile unit 309.

In the shown embodiment, the provided surroundings sensor data 305 originate from a plurality of different mobile units 309.

In the shown embodiment, the mobile units 309 are configured as vehicles. The surroundings sensor data 305 can be radar data, LiDAR data, ultrasonic data or camera data, for instance.

The surroundings sensor data 305 each have a position value 315 that is defined by a pose of the respective mobile unit 309 providing the surroundings sensor data 305.

In the shown embodiment, the respective position value 315 is based on data from a global navigation satellite system 333.

In addition to the surroundings sensor data 305, the data set generation module 327 also receives map data 311 from an electronic map 313. In the shown embodiment, the electronic map 313 is embodied as an electronic road map and shows the course of multiple roads 331 of a road network.

To generate the training data set 301, the data set generation module 327 first determines a respective position value 315 for the surroundings sensor data 305. The position value 315 is defined by a pose of the respective mobile unit 309 at the time the surroundings sensor data 305 were recorded. In the shown embodiment, the position value 315 can, for instance, be provided by the global navigation satellite system 333. The position value 315 can be a corresponding GPS value, for example.

A deviating position value 317 is then generated by the data set generation module 327 based on the ascertained position value 315. The deviating position value 317 deviates from the position value 315 by a selectable but defined deviation value 319.

For this purpose, the deviating position value 317 can be generated by shifting the position value 315 along a shift axis by a shift value. Alternatively or additionally, the deviating position value 317 can be generated by rotating the position value 315 about a rotation axis. The shift causes a change in the positioning of the pose of the respective mobile unit 309, while the rotation causes a change in the orientation of the pose relative to a fixed reference system.

Alternatively or additionally, the deviating position value 317 can be calculated from the position value 315 taking into account a random distribution. The random distribution can be configured as a normal distribution or uniform distribution with the position value 315 in a center of the random distribution. A maximum deviation value 319 between the deviating position value 317 and the position value 315 can be specified via a predefined limit value that can be defined by a width value of the random distribution, for instance.

Alternatively or additionally, the deviating position value 317 can be ascertained based on errors or deviations between the data of the plurality of mobile units 309 provided by the global navigation satellite system 333. The respective inaccuracies or errors are added to or subtracted from the actual position values 315 in accordance with a predefined rule.

Based on the ascertained deviating position value 317, the data set generation module then ascertains 327 a map section 321 based on the electronic map 313. The map section 321 is defined by a spatial region of the electronic map 313 disposed around the deviating position value 317. The map section 321 thus depicts the surroundings of the respective mobile unit 309 at least partially. The map section 321 is shifted or rotated relative to the surroundings sensor data 305 by the deviation value 319, however. The surroundings sensor data 305 of a mobile unit 309, that are respectively centered around the position value 315, and the map section 321 associated with the surroundings sensor data 305 depict the same surroundings of the respective mobile unit 309, but are shifted and/or rotated relative to one another by the deviation value 319.

This ensures that the surroundings sensor data 305 with the position value 315 and the associated map section 321, which is aligned around the deviating position value 317 ascertained based on the position value 315, exhibit an inaccuracy relative to one another that is represented as the deviation value 319. This makes it possible to simulate the inaccuracy in the pose determination by the respective mobile unit 309 when generating the surroundings sensor data 305. A corresponding inaccuracy of the pose determination in turn leads to a deviation of the corresponding surroundings sensor data 305 from the respective map section 321. Such inaccuracies in the pose determination are to be expected in particular in the case of mobile units 309 with low-quality surroundings sensors 307.

After the map section 321 has been generated, the map section 321 can be displayed in a bird's eye view.

The data set generation module 327 then combines the surroundings sensor data 305 and the respective associated map section 321 into a data set unit 323. The respective data set unit 323 is then integrated into the training data set 301.

Each data set unit 323 thus includes a set of surroundings sensor data 305 that are each assigned to the original position value 315 and a corresponding map section 321 that is assigned to the deviating position value 317 ascertained based on the original position value 315.

A plurality of such data set units 323 are generated to generate the training data set 301. The data set units 323 can be generated with different deviation values 319 between the position value 315 of the respective surroundings sensor data 305 and the deviating position value 317 of the respective map section 321. The magnitude of the respective deviation value 319 is freely selectable and can be selected in relation to the desired performance of the correspondingly trained map generation module 303.

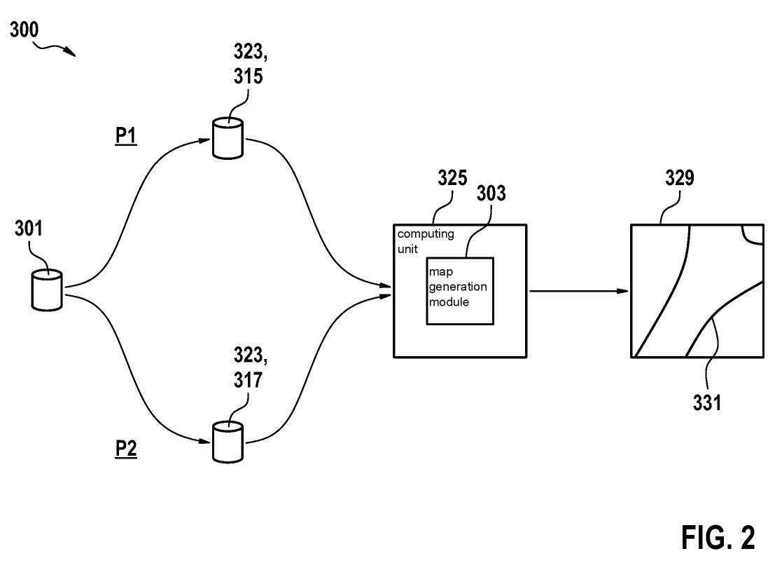

FIG. 2 shows a schematic illustration of a method 200 for training a map generation module 303 according to one embodiment.

In the shown embodiment, first, a training data set 301 generated according to the method steps mentioned in FIG. 1 is provided to train the map generation module 303. Based on the data set units 323 of the training data set 301, the to-be-trained map generation module 303 is subsequently trained to generate a corresponding map representation 329 of the surroundings based on surroundings sensor data 305 and map sections 321 that each depict the same surroundings of a corresponding mobile unit 309 at least partially. The map representation 329 includes information from the surroundings

sensor data 305 along with information from the map section 321. The information from the map section 321 can, for instance, include information relating to the following elements: lane marking, lane center line, road signs, traffic rules, topological features of the road network, such as bus stops or parking spaces.

The training of the map generation module 303 can be carried out in accordance with training types known from the prior art, for example supervised or unsupervised. The map generation module 303 can be configured as a corresponding artificial intelligence.

In the shown embodiment, the training of the map generation module 303 comprises a first training phase P1 and a temporally later second training phase P2.

In the first training phase P1, the map generation module 303 is trained on data set units 323 the deviation values 319 of which between the position values 315 of the surroundings sensor data 305 and the deviating position value 317 of the corresponding map section 321 reach or fall below a predefined limit value. The training of the map generation module 303 in the first training phase P1 can in particular be carried out primarily on data set units 323 in which both the surroundings sensor data 305 and the map section 321 are disposed around the same original position value 315; the deviation value is thus zero.

In the temporally later second training phase P2, the map generation module 303 is then trained on data set units 323 the deviation values 319 of which between the position value 315 of the surroundings sensor data 305 and the deviating position value 317 of the respective map section 321 exceed the predefined limit value.

The map generation module 303 can thus initially be trained on the unadulterated data with original position values 315 in the first training phase P1. This makes it possible to achieve the precision of the generation of the map representation 329.

In the second training phase P2, the map generation module 303, which has been pretrained on the unadulterated data set units 323 and is already functioning with acceptable performance, can then be trained taking into account the inaccuracies of the pose determination in the form of the data set units 323 with substantial deviation values 319 between the position value 315 of the surroundings sensor data 305 and the deviating position value 317 of the respective associated map section 321.

For this purpose, according to one embodiment, the proportion of the data set units 323 with a deviation value 319 of the data set units 323 used for training can be gradually increased in the second training phase P2 as training progresses.

Alternatively or additionally, data set units 323 with gradually increasing deviation values 319 can be taken into account in the second training phase P2 as training progresses.

This allows the map generation module 303 that has already been pretrained for the unadulterated data to gradually be introduced to taking into account inaccuracies in the pose determination when the respective mobile units 309 generate the surroundings sensor data 305, which in the present method is taken into account via the deviation values 319 between the position values 315 of the surroundings sensor data 305 and the deviating position values 317 of the respective map sections 321 of the data set units 323.

Dividing the training into the first and the second training phases P1, P2 makes it possible to precisely take into account the inaccuracies in the pose determination when generating the map representation 329. The correspondingly trained map generation module 303 is thus capable of generating map representations 329 with high precision based on surroundings sensor data 305 and corresponding map sections 321; both for surroundings sensor data 305 with high accuracy in the pose determination and surroundings sensor data 305 with reduced accuracy in the pose determination.

The correspondingly trained map generation module 303 is in particular configured to carry out an online map generation. In use, the trained map generation module 303 is in particular configured to take into account the currently generated surroundings sensor data 305 from the vehicle's surroundings sensor 307 and the map data 311 from a prestored electronic road map 313, while the vehicle is in motion, in order to use these data to generate map representations 329 that depict the current surroundings of the moving vehicle and take into account the information from the surroundings sensor data 305 and the information from the electronic road map 313, which is used in the described method as the map priority.

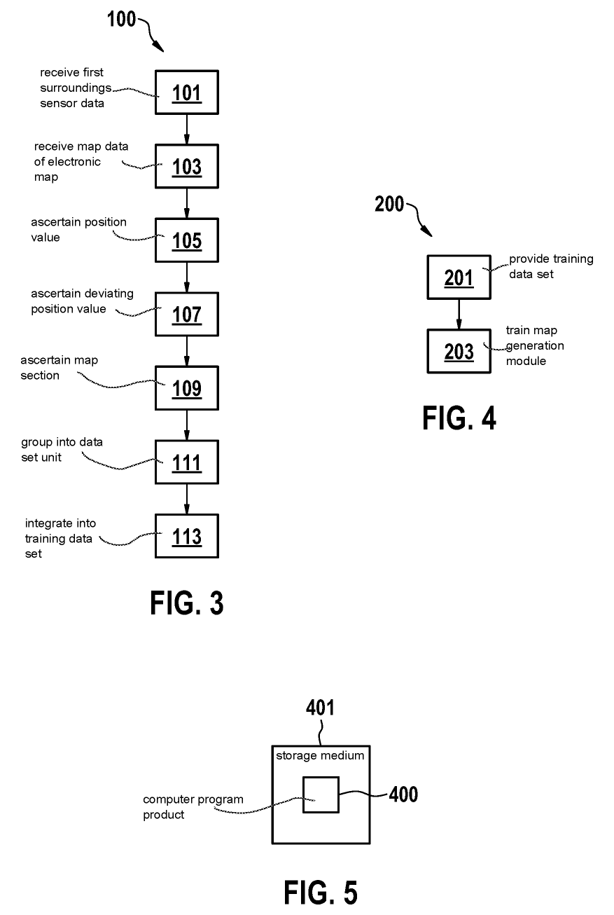

FIG. 3 shows a flow chart of the method 100 for generating a training data set 301 for training a map generation module 303 according to one embodiment.

To generate the training data set, first surroundings sensor data 305 from the surroundings sensor 307 of the mobile unit 309 are received in a first method step 101. The surroundings sensor data 305 depict the surroundings of the mobile unit 309 at least partially.

In a further method step 103, the map data 311 of the electronic map 313 are received. The electronic map 313 depicts the surroundings of the mobile unit 309 at least partially or comprises information relating to the respective surroundings.

In a further method step 105, a position value 315 of the surroundings sensor data 305 is ascertained. The position value 315 is defined by the pose of the respective mobile unit 309 at the time the surroundings sensor data 305 were recorded.

In a further method step 107, a deviating position value 317 is ascertained based on the position value 315 of the surroundings sensor data 305. The deviating position value 317 deviates from the original position value 315 by a freely selectable but defined deviation value 319.

In a further method step 109, a map section 321 is ascertained based on the electronic map 313. The map section 321 is defined by a defined spatial region of the electronic map 313 disposed around the deviating position value 317.

In a further method step 111, the surroundings sensor data 305 with the position value 315 and the map section 321 with the deviating position value 317 are grouped into a data set unit 323.

In a further method step 113, the correspondingly generated data set unit 323 is integrated into the training data set 301.

The integration of the data set unit 323 into the training data set 301 can also include the respective data set unit 323 representing the first data set unit 323 of the training data set 301.

FIG. 4 shows a flow chart of the method 200 for training a map generation module 303 according to one embodiment.

To train the map generation module 303, a training data set 301 generated according to the above-described method steps of the method 100 is first provided in a first method step 201.

In a further method step 203, the respective map generation module 303 is trained based on the training data set 301 to generate a map representation. The corresponding map representation 329 includes information from the electronic map 313 and information from the surroundings sensor data 305.

The map generation module 303 is in particular capable of carrying out online map creation. During operation of the vehicle, the information from the surroundings sensor data 305 and the information from the offline electronic road map is processed in real time and a corresponding map representation 329 is generated.

The electronic map 313 is in particular an offline map, whereas the map representation 329 is an online map and represents the current state of the surroundings of the mobile unit 309, i.e. the vehicle.

FIG. 5 shows a schematic illustration of a computer program product 400 comprising instructions that, when the program is executed by a data processing unit, cause said data processing unit to carry out the method 100 for generating a training data set 301 for training a map generation module 303 and/or the method 200 for training a map generation module 303.

In the shown embodiment, the computer program product 400 is stored on a storage medium 401. The storage medium 401 can be any storage medium known from the prior art.

What is claimed is:

1. A computer-implemented method for generating a training data set for training a map generation module, comprising the following steps:
receiving surroundings sensor data from a surroundings sensor of a mobile unit, wherein the surroundings sensor data depict surroundings of the mobile unit at least partially;
receiving map data from an electronic map, wherein the electronic map depicts the surroundings of the mobile unit at least partially and/or includes information relating to the surroundings of the mobile unit;
ascertaining a position value of the surroundings sensor data, wherein the position value of the surroundings sensor data is defined by a pose of the mobile unit;
ascertaining a deviating position value based on the position value, wherein the deviating position value deviates from the position value of the surroundings sensor data by a deviation value;
ascertaining a map section of the electronic map based on the deviating position value, wherein the map section is disposed around the deviating position value of the surroundings sensor data;
grouping the surroundings sensor data and the ascertained map section into a data set unit; and
integrating the data set unit into the training data set.

2. The method according to claim 1, wherein: (i) the deviating position value is ascertained by shifting the position value of the surroundings sensor data along a shift axis by a shift value, and/or (ii) the deviating position value is ascertained by rotating the position value of the surroundings sensor data about a rotation axis by a rotation value.

3. The method according to claim 1, wherein the deviating position value is ascertained based on a random distribution of the position value, wherein the random distribution is limited by a predefined limit value, and wherein the predefined limit value defines a maximum permissible deviation of the deviating position value from the position value.

4. The method according to claim 1, wherein the position value of the surroundings sensor data is based on data from a global navigation satellite system, and wherein the deviating position value is ascertained based on the position value taking into account an error value of the position value ascertained based on the data from the global navigation satellite system.

5. The method according to claim 1, wherein the map section is converted into a bird's eye view.

6. The method according to claim 1, wherein a plurality of data set units with different deviation values between the position value and the deviating position value of the surroundings sensor data are generated.

7. The method according to claim 1, wherein the surroundings sensor data are based on fleet data from a plurality of mobile units.

8. The method according to claim 1, wherein the mobile unit is a vehicle, and wherein the electronic map is an electronic road map of a road network.

9. The method according to claim 1, wherein: (i) the surroundings sensor data include data from the following list: radar data, LiDAR data, ultrasonic data, camera data, and/or (ii) the information of the electronic map includes information relating to elements from the list: lane marking, lane center line, road signs, topological features.

10. A training data set for training a map generation module, wherein the training data set includes a plurality of data set units which each include respective surroundings sensor data and a corresponding map section, and wherein the training data set is generated according to a method for generating a training data set, comprising the following steps:
for each of the plurality of data set units:
receiving respective surroundings sensor data from a surroundings sensor of a mobile unit, wherein the surroundings sensor data depict surroundings of the mobile unit at least partially,
receiving map data from an electronic map, wherein the electronic map depicts the surroundings of the mobile unit at least partially and/or includes information relating to the surroundings of the mobile unit,
ascertaining a position value of the respective surroundings sensor data, wherein the position value of the respective surroundings sensor data is defined by a pose of the mobile unit,
ascertaining a deviating position value based on the position value, wherein the deviating position value deviates from the position value of the surroundings sensor data by a deviation value,
ascertaining a corresponding map section of the electronic map based on the deviating position value, wherein the map section is disposed around the deviating position value of the surroundings sensor data,
grouping the respective surroundings sensor data and the ascertained corresponding map section into the data set unit, and
integrating the data set unit into the training data set.

11. A method for training a map generation module, comprising the following steps:
providing a training data set, wherein the training data set includes a plurality of data set units which each include respective surroundings sensor data and a corresponding map section, and wherein the training data set is generated according to a method for generating a training data set, comprising the following steps:
for each of the plurality of data set units:
receiving respective surroundings sensor data from a surroundings sensor of a mobile unit, wherein the surroundings sensor data depict surroundings of the mobile unit at least partially,
receiving map data from an electronic map, wherein the electronic map depicts the surroundings of the mobile unit at least partially and/or includes information relating to the surroundings of the mobile unit,
ascertaining a position value of the respective surroundings sensor data, wherein the position value of the respective surroundings sensor data is defined by a pose of the mobile unit,
ascertaining a deviating position value based on the position value, wherein the deviating position value deviates from the position value of the surroundings sensor data by a deviation value,
ascertaining a corresponding map section of the electronic map based on the deviating position value, wherein the map section is disposed around the deviating position value of the surroundings sensor data,
grouping the respective surroundings sensor data and the ascertained corresponding map section into the data set unit, and
integrating the data set unit into the training data set; and
training the map generation module to generate a respective map representation based on the data set units of the training data set, wherein the respective map representation includes information from the respective map representation and information from respective surroundings sensor data and depicts surroundings of a respective mobile unit at least partially.

12. The method according to claim 11, wherein the training of the map generation module includes a first training phase and a temporally later second training phase, wherein, in the first training phase, the map generation module is trained on data set units of the training data set which each have a deviation value between the position value and the deviating position value that is less than or equal to a predefined limit value, and wherein, in the second training phase, the map generation module is trained on data set units of the training data set which each have a deviation value between the position value and the deviating position value that is greater than the predefined limit value.

13. The method according to claim 12, wherein: (i) in the second training phase, a proportion of the data set units with a deviation value greater than the predefined limit value used for training is gradually increased, and/or (ii) in the second training phase, data set units with gradually increasing deviation values between the position value and the deviating position value are used for training.

14. A non-transitory computer-readable medium on which is stored a map generation module, wherein the map generation module was trained according to a method for training a map generation module comprising the following steps:
providing a training data set, wherein the training data set includes a plurality of data set units which each include respective surroundings sensor data and a corresponding map section, and wherein the training data set is generated according to a method for generating a training data set, comprising the following steps:
for each of the plurality of data set units:
receiving respective surroundings sensor data from a surroundings sensor of a mobile unit, wherein the surroundings sensor data depict surroundings of the mobile unit at least partially,
receiving map data from an electronic map, wherein the electronic map depicts the surroundings of the mobile unit at least partially and/or includes information relating to the surroundings of the mobile unit,
ascertaining a position value of the respective surroundings sensor data, wherein the position value of the respective surroundings sensor data is defined by a pose of the mobile unit,
ascertaining a deviating position value based on the position value, wherein the deviating position value deviates from the position value of the surroundings sensor data by a deviation value,
ascertaining a corresponding map section of the electronic map based on the deviating position value, wherein the map section is disposed around the deviating position value of the surroundings sensor data,
grouping the respective surroundings sensor data and the ascertained corresponding map section into the data set unit, and
integrating the data set unit into the training data set; and
training the map generation module to generate a respective map representation based on the data set units of the training data set, wherein the respective map representation includes information from the respective map representation and information from respective surroundings sensor data and depicts surroundings of a respective mobile unit at least partially;
wherein the map generation module, when executed by a computer, causes the computer to generate a respective map representation of respective surroundings of a respective mobile unit based on respective surroundings sensor data and an electronic map.

15. A device comprising:
a computing unit configured to execute a method for training a map generation module, comprising the following steps:
providing a training data set, wherein the training data set includes a plurality of data set units which each include respective surroundings sensor data and a corresponding map section, and wherein the training data set is generated according to a method for generating a training data set, including the following steps:
for each of the plurality of data set units:
receiving respective surroundings sensor data from a surroundings sensor of a mobile unit, wherein the surroundings sensor data depict surroundings of the mobile unit at least partially,
receiving map data from an electronic map, wherein the electronic map depicts the surroundings of the mobile unit at least partially and/or includes information relating to the surroundings of the mobile unit,
ascertaining a position value of the respective surroundings sensor data, wherein the position value of the respective surroundings sensor data is defined by a pose of the mobile unit,
ascertaining a deviating position value based on the position value, wherein the deviating position value deviates from the position value of the surroundings sensor data by a deviation value,
ascertaining a corresponding map section of the electronic map based on the deviating position value, wherein the map section is disposed around the deviating position value of the surroundings sensor data,
grouping the respective surroundings sensor data and the ascertained corresponding map section into the data set unit, and
integrating the data set unit into the training data set;
training the map generation module to generate a respective map representation based on the data set units of the training data set, wherein the respective map representation includes information from the respective map representation and information from respective surroundings sensor data and depicts the respective surroundings of a respective mobile unit at least partially.

16. A non-transitory medium on which is stored a computer program product including instructions for training a map generation module, the instructions, when executed by a data processor, causing the data processor to perform the following steps:
providing a training data set, wherein the training data set includes a plurality of data set units which each include respective surroundings sensor data and a corresponding map section, and wherein the training data set is generated according to a method for generating a training data set, comprising the following steps:
for each of the plurality of data set units:
receiving respective surroundings sensor data from a surroundings sensor of a mobile unit, wherein the surroundings sensor data depict surroundings of the mobile unit at least partially,
receiving map data from an electronic map, wherein the electronic map depicts the surroundings of the mobile unit at least partially and/or includes information relating to the surroundings of the mobile unit,
ascertaining a position value of the respective surroundings sensor data, wherein the position value of the respective surroundings sensor data is defined by a pose of the mobile unit,
ascertaining a deviating position value based on the position value, wherein the deviating position value deviates from the position value of the surroundings sensor data by a deviation value,
ascertaining a corresponding map section of the electronic map based on the deviating position value, wherein the map section is disposed around the deviating position value of the surroundings sensor data,
grouping the respective surroundings sensor data and the ascertained corresponding map section into the data set unit, and
integrating the data set unit into the training data set; and
training the map generation module to generate a respective map representation based on the data set units of the training data set, wherein the respective map representation includes information from the respective map representation and information from respective surroundings sensor data and depicts surroundings of a respective mobile unit at least partially.
